(19) United States
(12) Patent Application Publication
(10) Pub. No.: US 2025/0256964 A1
(43) Pub. Date: Aug. 14, 2025

(54) METHOD FOR PREPARING LITHIUM IRON PHOSPHATE AND USE THEREOF

(71) Applicants: Guangdong Brunp Recycling Technology Co., Ltd., Foshan, Guangdong (CN); Hunan Brunp Recycling Technology Co., Ltd., Changsha, Hunan (CN); Hunan Brunp EV Recycling Co., Ltd., Changsha, Hunan (CN)

(72) Inventors: Haijun Yu, Foshan, Guangdong (CN); Yinghao Xie, Foshan, Guangdong (CN); Aixia Li, Foshan, Guangdong (CN); Xuemei Zhang, Foshan, Guangdong (CN); Changdong Li, Foshan, Guangdong (CN)

(21) Appl. No.: 18/850,072

(22) PCT Filed: Mar. 20, 2023
(86) PCT No.: PCT/CN2023/082553

§ 371 Date: Sep. 24, 2024

(30) Foreign Application Priority Data
May 25, 2022 (CN) 202210575070.4

(51) Int. Cl. C01B 25/45; H01M 4/58

(52) U.S. Cl. CPC C01B 25/45; H01M 4/5825; C01P 2004/03; C01P 2006/11; C01P 2006/40

(57) ABSTRACT

The present disclosure provides a method for preparing lithium iron phosphate and use thereof. The method comprises: adding a mixed solution of ferrous salt and ammonium dihydrogen phosphate, a citric acid solution and a pH adjusting agent in parallel into a first reactor for reaction, and simultaneously extracting the materials in the first reactor to a second reactor, and adding a copper salt solution and a sodium hydroxide solution to the second reactor for reaction, and refluxing the materials in the second reactor into the first reactor, mixing the solid material obtained in the reaction with a lithium source, and calcining the mixture in an ammonia gas stream to obtain lithium iron phosphate. This method can prepare a lithium iron phosphate precursor with a spherical structure, thereby improving the electrochemical performance of the subsequently prepared lithium iron phosphate material, which has a relatively high conductivity.

### TECHNICAL FIELD

The present disclosure relates to the technical field of lithium-ion battery cathode materials, and in particular to a method for preparing lithium iron phosphate and use thereof.

### BACKGROUND

With the continuous development of the electric vehicle market, more and more attention has been paid to safety and economy of electric vehicles, especially in terms of safety. Fire accidents of electric vehicle power supply are often reported. Power supply is a key component of electric vehicles, and power lithium-ion battery is commonly recognized as the most ideal power supply. Whether a lithium-ion battery can be widely used mainly depends on its indicators such as performance, price and safety. Cathode material is the core component of a power lithium-ion battery, and the cost and performance thereof will directly affect the overall cost and performance of the battery. Therefore, the development of cathode materials with excellent performance and low price is the focus of lithium-ion battery research.

Compared with ternary batteries, lithium iron phosphate batteries have advantages of higher safety and lower cost. They have advantages of good thermal stability, long cycle life, environmental friendliness, rich raw material sources, etc. Lithium iron phosphate cathode materials are the most potential cathode materials for power lithium-ion batteries at present, and are gaining the favor of more automobile manufacturers, and the market share thereof is increasing. Lithium iron phosphate has broad application prospects.

Due to the poor conductivity of lithium iron phosphate, a certain proportion of conductive carbon powder needs to be added. The carbon powder can not only be coated on the surface of lithium iron phosphate to increase conductivity, but also act as a reducing agent for carbothermal reaction, creating a reducing atmosphere required by lithium iron phosphate regeneration. Although a large amount of conductive carbon powder coating on lithium iron phosphate can improve its conductivity, large volume and weight limit the improvement of the specific capacitance of the cathode material. Some patent documents disclose using expensive carbon nanotubes, graphene or conductive polymer materials to increase the conductivity of lithium iron phosphate, but the practicability is not strong. For example, Chinese Patent No. CN102136576B discloses a conductive agent for a lithium iron phosphate battery and a preparation method thereof, in which a carbon nanotube/conductive carbon composite material is used as a conductive agent. Chinese Patent No. CN106159265B discloses a preparation method of cathode slurry for lithium iron phosphate battery containing a graphene composite conductive agent. Chinese Patent No. CN104795569B discloses a conductive polymer composite conductive agent for lithium iron phosphate battery and a preparation method thereof.

In order to improve the performance of LifePO₄, the ionic diffusion coefficient and electronic conductivity of LifePO₄ has been improved by coating conductive materials on the surface, doping high-valent metal cations, and synthesizing nanomaterials, which makes LiFePO4 practical. However, its low tap density has not been improved. According to long-term research, it is found that the tap density and volume specific capacity of the material can be improved by spheroidization, and the spherical particles have good processability, so that the material can be better modified to improve its electrochemical performance. Moreover, lithium iron phosphate inherits the morphology of its precursor to some extent, and lithium iron phosphate crystals can grow directly on its precursor crystals, and the morphology of the precursor directly determines the morphology of lithium iron phosphate. In general preparation methods of a lithium iron phosphate precursor, a ferrous salt is used as an iron source, and chemical oxidants such as hydrogen peroxide need to be introduced for oxidation, which costs highly. Moreover, most of the prepared particles are amorphous, small nano-sized particles, and the tap density thereof is low, which also limits the specific capacitance of a cathode material.

Therefore, how to develop to improve the conductivity of lithium iron phosphate and how to improve the degree of sphericity of lithium iron phosphate have become technical problems to be solved urgently.

### SUMMARY

The present disclosure aims to solve at least one of the technical problems existing in the above-mentioned prior art. In view of this, the present disclosure provides a method for preparing lithium iron phosphate and use thereof. This method can prepare a lithium iron phosphate precursor with a spherical structure, thereby improving the electrochemical performance of the subsequently prepared lithium iron phosphate material, which has relatively high conductivity.

According to one aspect of the present disclosure, a method for preparing lithium iron phosphate is proposed, comprising the following steps:
S1: adding a base solution into a first reactor, and then adding a mixed solution of a ferrous salt and ammonium dihydrogen phosphate, a citric acid solution and a pH adjusting agent in parallel to react, simultaneously extracting materials in the first reactor to a second reactor, adding a copper salt solution and a sodium hydroxide solution to the second reactor to react, and refluxing materials in the second reactor into the first reactor;
S2: when the materials in the first reactor have a target particle size, performing solid-liquid separation to obtain a solid material; and
S3: mixing the solid material with a lithium source, and then calcining a resulting mixture in an ammonia gas stream to obtain the lithium iron phosphate.

In some embodiments of the present disclosure, in step S1, the ferrous salt is at least one of ferrous sulfate and ferrous chloride.

In some embodiments of the present disclosure, in step S1, in the mixed solution, a concentration of the ferrous salt is 0.5-1.0 mol/L, and a concentration of ammonium dihydrogen phosphate is 0.5-1.0 mol/L.

In some embodiments of the present disclosure, in step S1, a concentration of the citric acid solution is 0.5-1.0 mol/L.

In some embodiments of the present disclosure, in step S1, the pH adjusting agent is sodium hydroxide or ammonia water and a concentration of the pH adjusting agent is 4.0-8.0 mol/L.

In some embodiments of the present disclosure, in step S1, the base solution is a mixed solution of sodium hydroxide and citric acid, or a mixed solution of ammonia water and citric acid, and in the base solution, a pH is 5.0-6.0, and a citric acid concentration is 2.0-10.0 g/L.

In some embodiments of the present disclosure, in step S1, in the second reactor, feeding flow rates of the copper salt solution and the sodium hydroxide solution are controlled according to a molar ratio of the copper salt to the sodium hydroxide of 1: (2-2.1).

In some embodiments of the present disclosure, in step S1, a reaction temperature in the first reactor is controlled to be 40-50° C., a pH is controlled to be 5.0-6.0, and a concentration of citric acid is controlled to be 2.0-10.0 g/L. Further, the stirring speed in the first reactor is 120-200 r/min.

In some embodiments of the present disclosure, in step S1, feeding flow rates of the mixed solution and the copper salt solution are controlled according to a molar ratio of a ferrous salt to a copper salt of (50-100):1.

In some embodiments of the present disclosure, in step S1, a concentration of the copper salt solution is 1.0-2.0 mol/L.

In some embodiments of the present disclosure, in step S1, the copper salt solution is at least one of a copper sulfate solution and a copper chloride solution.

In some embodiments of the present disclosure, in step S2, the target particle size is D50 of 1.0-5.0 μm.

In some embodiments of the present disclosure, in step S2, the method further comprises a step of washing and drying the solid material after the solid-liquid separation, wherein the drying is conducted at a temperature of 80-100° C. for 2-4 h.

In some embodiments of the present disclosure, in step S3, the lithium source is at least one of lithium hydroxide and lithium carbonate.

In some embodiments of the present disclosure, in step S3, a flow rate of the ammonia gas stream is 500-800 mL/min.

In some embodiments of the present disclosure, in step S3, a molar ratio of Fe in the solid material to Li in the lithium source is 1:(1.0-1.2).

In some embodiments of the present disclosure, in step S3, the calcination is conducted as follows: first calcining at 300-400° C. for 1-3 h, and then calcining at 600-900° C. for 8-48 h.

In some embodiments of the present disclosure, in step S3, the tap density of the lithium iron phosphate is 1.55-1.65 g/cm³.

The present disclosure also provides use of the method in the preparation of lithium ion batteries.

According to a preferred embodiment of the present disclosure, the present disclosure has at least the following beneficial effects:
1. In the present disclosure, spherical ferrous ammonium phosphate is prepared by co-precipitation of a ferrous source and a phosphorus source. In the co-precipitation process, a precipitate doped with copper hydroxide is produced, and then it is calcined with a lithium source in an ammonia gas stream, so that the copper hydroxide is reduced to metallic copper, thereby obtaining a spherical lithium iron phosphate cathode material doped with metallic copper. The reaction equations are as follows.

In the co-precipitation reaction:

NH₄⁺+Fe²⁺+PO₄³⁻→NH₄FePO₄;

Cu²⁺+2OH⁻→Cu(OH)₂;

During the calcination in an ammonia gas stream:

3Cu(OH)₂+2NH₃→3Cu+6H₂O+N₂;

LiOH+NH₄FePO₄→NH₃+LiFePO₄+H₂O.
2. In the present disclosure, ammonium iron phosphate is synthesized in the first reactor, and copper hydroxide is doped in the second reactor to avoid the generation of copper phosphate, so that copper hydroxide is doped before ammonium iron phosphate particles grow up, and is uniformly dispersed in the ammonium iron phosphate particles. The spherical ammonium iron phosphate is prepared through the co-precipitation reaction and acts as a precursor for the subsequent production of a lithium iron phosphate cathode material. In the subsequent calcination process, ammonia gas is used as a reducing gas to further reduce copper hydroxide to metallic copper, which enhances the conductivity of the material and avoids the addition of carbon materials (the conductivity of copper is 10,000 times that of amorphous carbon). Furthermore, lithium iron phosphate cathode material inherits the morphology of ferrous ammonium phosphate to some extent, so that spherical lithium iron phosphate is obtained. Spheroidization is beneficial to improve the tap density and volume specific capacity of the material, so that the lithium iron phosphate cathode material with high tap density and high conductivity is finally obtained.

### BRIEF DESCRIPTION OF THE DRAWINGS

The present disclosure will be further described below in conjunction with the drawings and embodiments, wherein:

FIG. 1 is a schematic diagram showing a synthetic process of ferrous ammonium phosphate of the present disclosure;

FIG. 2 is a scanning electron microscopy (SEM) image of ferrous ammonium phosphate prepared in Example 1 of the present disclosure;

FIG. 3 is an SEM image of lithium iron phosphate prepared in Example 1 of the present disclosure.

### DETAILED DESCRIPTION OF EMBODIMENT

The concept of the present disclosure and the technical effects produced by the present disclosure will be clearly and completely described below with reference to the embodiments, so as to make the purpose, characteristics and effects of the present disclosure fully understood. Obviously, the described embodiments are only a part of the embodiments of the present disclosure, rather than all the embodiments. Based on the embodiments of the present disclosure, other embodiments obtained by those skilled in the art without creative efforts shall all fall within the protection scope of the present disclosure.

### EXAMPLE 1

In the present example, a lithium iron phosphate was prepared. The specific process was as follows.
Step 1: A ferrous sulfate solution with a concentration of 1.0 mol/L was prepared.
Step 2: An ammonium dihydrogen phosphate solution with a concentration of 1.0 mol/L was prepared as a precipitant.
Step 3: The ferrous salt solution prepared in step 1 and the ammonium dihydrogen phosphate solution prepared in step 2 were mixed according to a volume ratio of 1:1 to obtain a mixed solution.
Step 4: A citric acid solution with a concentration of 0.5 mol/L was prepared as a complexing agent.
Step 5: An ammonia water solution with a concentration of 8.0 mol/L was prepared as a pH adjusting agent.

Step 6: A copper sulfate solution with a concentration of 1.0 mol/L was prepared.

Step 7: A base solution was added to a reaction kettle until the stirring paddle at bottom is immersed, then the stirring was started, wherein the base solution was a mixed solution of ammonia water and citric acid, a pH value of the base solution was 6.0, and a concentration of citric acid was 2.0 g/L.

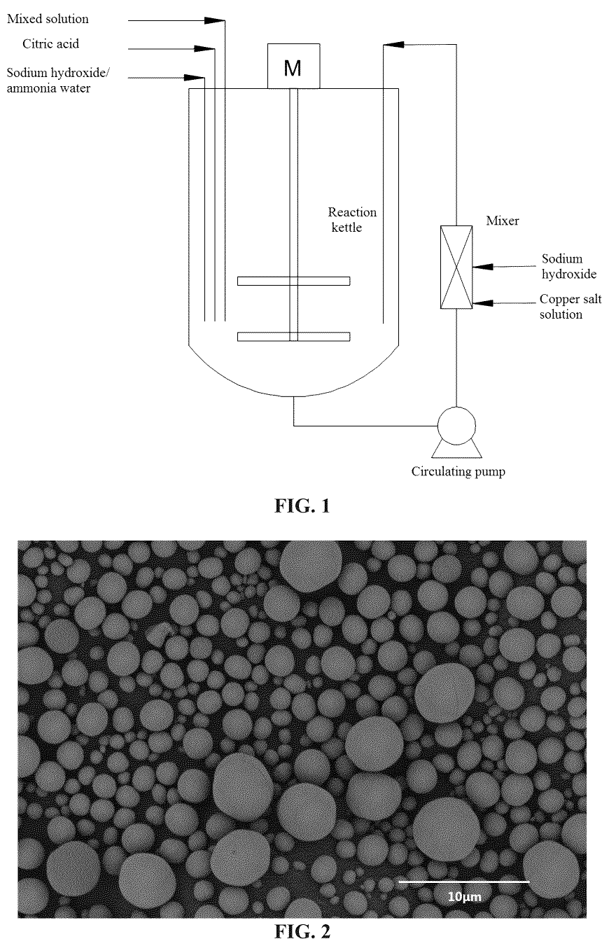

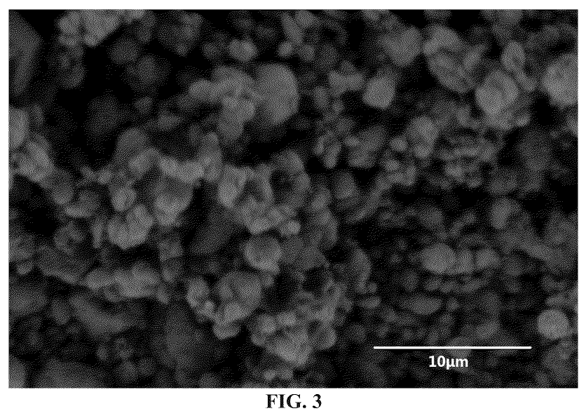

Step 8: Referring to FIG. 1, the mixed solution in step 3, the citric acid solution prepared in step 4 and the ammonia water solution prepared in step 5 were fed to the reaction kettle in parallel for reaction; meanwhile, the circulating pump was started. The materials entered a mixer from the bottom of the reaction kettle. The copper salt solution and the sodium hydroxide solution were added to the mixer, and mixed in the mixer, and then the mixture was returned to the reaction kettle from the top of the reaction kettle. During the whole process, the reaction temperature in the reaction kettle was controlled to be 40° C., the pH was controlled to be 6.0, the concentration of citric acid was controlled to be 2.0 g/L, and the stirring speed was controlled to be 120 r/min. In the mixer, feed flow rates of the copper salt solution and the sodium hydroxide solution were controlled according to the molar ratio of copper salt to sodium hydroxide of 1:2, and feed flow rates of the mixed solution and the copper sulfate solution were controlled according to the molar ratio of ferrous salt to copper salt of 100:1.

Step 9: When it was detected that D50 of the materials in the reaction kettle reached 5.0 μm, the feeding was stopped.

Step 10: Solid-liquid separation was performed to the materials in the reaction kettle to obtain a solid material. Then, the solid material was washed with deionized water and dried at 80° C. for 4 hours to obtain spherical ferrous ammonium phosphate.

Step 11: According to Fe: Li=1:1.0, ferrous ammonium phosphate and lithium hydroxide were mixed and then calcined in an ammonia gas stream of 500 mL/min. The resulting mixture was firstly calcined at a temperature of 300° C. for 3 h, and then calcined at a temperature of 600° C. for 48 h, then the spherical lithium iron phosphate cathode material was obtained.

### EXAMPLE 2

In the present example, a lithium iron phosphate was prepared. The specific process was as follows.
Step 1: A ferrous chloride solution with a concentration of 1.5 mol/L was prepared.
Step 2: An ammonium dihydrogen phosphate solution with a concentration of 1.5 mol/L was prepared as a precipitant.
Step 3: The ferrous salt solution prepared in step 1 and the ammonium dihydrogen phosphate solution prepared in step 2 were mixed according to a volume ratio of 1:1 to obtain a mixed solution.
Step 4: A citric acid solution with a concentration of 0.7 mol/L was prepared as a complexing agent.
Step 5: A sodium hydroxide solution with a concentration of 6.0 mol/L was prepared as a pH adjusting agent.
Step 6: A copper salt solution with a concentration of 1.5 mol/L was prepared, wherein the copper salt was copper sulfate and/or copper chloride.
Step 7: A base solution was added to a reaction kettle until the stirring paddle at bottom is immersed, then the stirring was started, wherein the base solution was a mixed solution of sodium hydroxide and citric acid, a pH value of the base solution was 5.5, and a concentration of citric acid was 6.0 g/L.
Step 8: The mixed solution in step 3, the citric acid solution prepared in step 4 and the sodium hydroxide solution prepared in step 5 were fed to the reaction kettle in parallel for reaction; meanwhile, the circulating pump was started. The materials entered a mixer from the bottom of the reaction kettle. The copper salt solution and the sodium hydroxide solution were added to the mixer, and mixed in the mixer, and then the mixture was returned to the reaction kettle from the top of the reaction kettle. During the whole process, the reaction temperature in the reaction kettle was controlled to be 45° C., the pH was controlled to be 5.5, the concentration of citric acid was controlled to be 6.0 g/L, and the stirring speed was controlled to be 160 r/min. In the mixer, feed flow rates of the copper salt solution and the sodium hydroxide solution were controlled according to the molar ratio of copper salt to sodium hydroxide of 1:2, and feed flow rates of the mixed solution and the copper salt solution were controlled according to the molar ratio of ferrous salt to copper salt of 80:1.
Step 9: When it was detected that D50 of the materials in the reaction kettle reached 3.0um, the feeding was stopped.
Step 10: Solid-liquid separation was performed to the materials in the reaction kettle to obtain a solid material. Then, the solid material was washed with deionized water and dried at 9° C. for 3 hours to obtain spherical ferrous ammonium phosphate.
Step 11: According to Fe: Li=1:1.1, ferrous ammonium phosphate and lithium carbonate were mixed and then calcined in an ammonia gas stream of 650 mL/min. The resulting mixture was firstly calcined at a temperature of 350° C. for 2 h, and then calcined at a temperature of 750° C.

### EXAMPLE 3

In the present example, a lithium iron phosphate was prepared. The specific process was as follows.
Step 1: A ferrous sulfate solution with a concentration of 2.0 mol/L was prepared.
Step 2: An ammonium dihydrogen phosphate solution with a concentration of 2.0 mol/L was prepared as a precipitant.
Step 3: The ferrous salt solution prepared in step 1 and the ammonium dihydrogen phosphate solution prepared in step 2 were mixed according to a volume ratio of 1:1 to obtain a mixed solution.
Step 4: A citric acid solution with a concentration of 1.0 mol/L was prepared as a complexing agent.
Step 5: A sodium hydroxide solution with a concentration of 8.0 mol/L was prepared as a pH adjusting agent.
Step 6: A copper sulfate solution with a concentration of 2.0 mol/L was prepared.
Step 7: A base solution was added to a reaction kettle until the stirring paddle at bottom is immersed, then the stirring was started, wherein the base solution was a mixed solution of sodium hydroxide and citric acid, a pH value of the base solution was 5.0, and a concentration of the citric acid was 10.0 g/L.
Step 8: The mixed solution in step 3, the citric acid solution prepared in step 4 and the sodium hydroxide solution prepared in step 5 were fed to the reaction kettle in parallel for reaction; meanwhile, the circulating pump was started. The materials entered a mixer from the bottom of the reaction kettle. The copper salt solution and the sodium hydroxide solution were added to the mixer, and mixed in the mixer, and then the mixture was returned to the reaction kettle from the top of the reaction kettle. During the whole process, the reaction temperature in the reaction kettle was controlled to be 50° C., the pH was controlled to be 5.0, the concentration of the citric acid was controlled to be 10.0 g/L, and the stirring speed was controlled to be 200 r/min. In the mixer, feed flow rates of the copper salt solution and the sodium hydroxide solution were controlled according to the molar ratio of copper salt to sodium hydroxide of 1:2, and the feed flow rates of the mixed solution and the copper 50:1.
Step 9: When it was detected that D50 of the materials in the reaction kettle reaches 1.0 μm, the feeding was stopped.
Step 10: Solid-liquid separation was performed to the materials in the reaction kettle to obtain a solid material. Then, the solid material was washed with deionized water and dried at 100° C. for 2 hours to obtain spherical ferrous ammonium phosphate.
Step 11: According to Fe: Li=1:1.2, ferrous ammonium phosphate and lithium hydroxide were mixed and then calcined in an ammonia gas stream of 800 mL/min. The resulting mixture was firstly calcined at a temperature of 400° C. for 1 h, and then calcined at a temperature of 900° C. for 8 h, then the spherical lithium iron phosphate cathode material was obtained.

### COMPARATIVE EXAMPLE

In the present comparative example, a lithium iron phosphate was prepared. The specific process was as follows.
Step 1: Ferrous sulfate and NaH2PO₄ was taken according to a molar ratio of 1:1, and dissolved in water and placed into a reaction kettle, so that the concentration of ferrous ions was 90 g/L.
Step 2: An excess amount of hydrogen peroxide with a mass concentration of 20% was added in to the reaction kettle.
Step 3: The temperature of the reaction kettle was raised to 90° C., sodium hydroxide was added to adjust the pH to 1.8, and the temperature was maintained for 1 h.
Step 4: Solid-liquid separation was performed, and the precipitate was washed with pure water to obtain a filter cake.
Step 5: The filter cake was dried at 105° C. for 8 h, and pulverized to obtain iron phosphate dihydrate.
Step 6: The iron phosphate dihydrate was calcined in a muffle furnace at 550° C. for 3 h, to obtain iron phosphate.
Step 7: According to the molar ratio of Li:P:Fe:glucose=1:1: 1:1, iron phosphate, glucose and lithium carbonate were added into deionized water respectively, and fully mixed and stirred in the mixing tank. The mixture was dried by spray, and kept in an inert atmosphere at 580° C. for 9 hours to obtain the lithium iron phosphate cathode material.

### Test Eample

The lithium iron phosphate cathode materials obtained in Examples 1-3 and Comparative example were tested according to “GB/T 5162 Metallic powders—Determination of tap density”. The results were shown in Table 1.

TABLE 1

| | Tap density g/cm³ |
|---|---|
| Example 1 | 1.63 |
| Example 2 | 1.56 |
| Example 3 | 1.58 |
| Comparative example | 1.37 |

It can be seen from Table 1 that the tap density of the lithium iron phosphate cathode material of each of the examples is significantly higher than that of the comparative example, indicating that the spherical lithium iron phosphate prepared by the co-precipitation method in the present disclosure is beneficial to improve the tap density of the material.

Each of the lithium iron phosphate cathode materials obtained in the examples and comparative example, acetylene black as a conductive agent and PVDF as a binding agent were mixed according to a mass ratio of 8:1:1, and a certain amount of organic solvent NMP was added. The resulting mixture was stirred, and then coated on aluminum foil to form a cathode sheet, the anode was a metal lithium sheet; the diaphragm was Celgard2400 polypropylene porous membrane; the solvent in the electrolyte was a solution composed of EC, DMC and EMC in a mass ratio of 1:1:1, and the solute was LiPF₆ with a concentration of 1.0 mol/L; a 2023 type button battery was assembled in a glove box.

The resistivity of each of the prepared cathode sheets was tested by a four-point resistivity tester, and the charge-discharge cycle performance test of the battery was carried out. Within the cut-off voltage range of 2.2˜4.3 V, the discharge specific capacity at 0.2 C and 1 C was tested. The results were shown in Table 2.

TABLE 2

| | Resistivity of | | |
|---|---|---|---|
| | the electrode | Discharge capacity | Discharge capacity |
| | sheet, Q · m | at 0.2 C, mAh/g | at 1 C, mAh/g |
| Example 1 | 137 | 168.9 | 160.3 |
| Example 2 | 128 | 168.4 | 159.8 |
| Example 3 | 114 | 167.7 | 159.5 |
| Comparative | 398 | 151.6 | 141.9 |
| example | | | |

It can be seen from Table 2 that the resistivity of the cathode sheet prepared from the lithium iron phosphate of each of the examples is significantly lower than that of the comparative example, and the amount of doped copper in the examples is significantly lower than the amount of carbon coated in the comparative example, indicating that a better electrical conductivity than the comparative example can be obtained. Furthermore, due to the carbon coated on the surface of the material and the lower tap density of the comparative example, the discharge capacity of the comparative example is also significantly lower than that of the examples.

The examples of the present disclosure have been described in detail above in conjunction with the drawings, but the present disclosure is not limited to the above-mentioned examples. Within the scope of knowledge possessed by those of ordinary skill in the art, various changes can also be made without departing from the spirit of the present disclosure. Furthermore, the examples and the features in the examples of the present disclosure can be combined with each other without conflict.

1. A method for preparing lithium iron phosphate, comprising the following steps:
S1: adding a base solution into a first reactor, then adding a mixed solution of a ferrous salt and ammonium dihydrogen phosphate, a citric acid solution and a pH adjusting agent in parallel to react, simultaneously extracting materials in the first reactor to a second reactor, adding a copper salt solution and a sodium hydroxide solution to the second reactor to react, and refluxing materials in the second reactor into the first reactor, wherein the base solution is a mixed solution of sodium hydroxide and citric acid, or a mixed solution of ammonia water and citric acid, and in the base solution, a pH is 5.0-6.0, and a citric acid concentration is 2.0-10.0 g/L;
S2: when the materials in the first reactor have a target particle size, performing solid-liquid separation to obtain a solid material; and
S3: mixing the solid material with a lithium source, and then calcining a resulting mixture in an ammonia gas stream to obtain the lithium iron phosphate.

2. The method according to claim 1, wherein in step S1, in the mixed solution, a concentration of the ferrous salt is 0.5-1.0 mol/L, and a concentration of ammonium dihydrogen phosphate is 0.5-1.0 mol/L.

3. The method according to claim 1, wherein in step S1, the pH adjusting agent is sodium hydroxide or ammonia water, and a concentration of the pH adjusting agent is 4.0-8.0 mol/L.

4. (canceled)

5. The method according to claim 1, wherein in step S1, in the second reactor, feeding flow rates of the copper salt solution and the sodium hydroxide solution are controlled according to a molar ratio of copper salt to sodium hydroxide of 1:(2-2.1).

6. The method according to claim 1, wherein in step S1, a reaction temperature in the first reactor is controlled to be 40-50° C., a pH is controlled to be 5.0-6.0,and a concentration of citric acid is controlled to be 2.0-10.0 g/L.

7. The method according to claim 1, wherein in step S1, feeding flow rates of the mixed solution and the copper salt solution are controlled according to a molar ratio of a ferrous salt to a copper salt of (50-100):1.

8. The method according to claim 1, wherein in step S3, a molar ratio of Fe in the solid material to Li in the lithium source is 1:(1.0-1.2).

9. The method according to claim 1, wherein in step S3, the calcination is conducted as follows: first calcining at 300-400° C. for 1-3 h, and then calcining at 600-900° C. for 8-48 h.

10. Lithium iron phosphate prepared by the method according to claim 1 in preparation of lithium ion batteries.

11. Lithium iron phosphate prepared by the method according to claim 2.

12. Lithium iron phosphate prepared by the method according to claim 3.

13. Lithium iron phosphate prepared by the method according to claim 5.

14. Lithium iron phosphate prepared by the method according to claim 6.

15. Lithium iron phosphate prepared by the method according to claim 7.

16. Lithium iron phosphate prepared by the method according to claim 8.

17. Lithium iron phosphate prepared by the method according to claim 9.
